(19) United States
(12) Patent Application Publication
(10) Pub. No.: US 2017/0044025 A1
(43) Pub. Date: Feb. 16, 2017

(54) REMOVAL OF BENZENE FROM WATER USING ALUMINUM OXIDE IMPREGNATED CARBON NANOTUBES ENHANCED

(71) Applicant: KING FAHD UNIVERSITY OF PETROLEUM AND MINERALS, Dhahran (SA)

(72) Inventors: Basim Ahmed ABUSSAUD, Dhahran (SA); Aamir Abbas, Dhahran (SA); Muataz Ali Atieh, Dhahran (SA)

(73) Assignee: KING FAHD UNIVERSITY OF PETROLEUM AND MINERALS, Dhahran (SA)

(21) Appl. No.: 14/823,696

(22) Filed: Aug. 11, 2015

(51) Int. Cl. C02F 1/28; C02F 1/32; B01J 20/20

(52) U.S. Cl. CPC C02F 1/288; B01J 20/205; C02F 1/281; C02F 1/283; C02F 1/32; C02F 2101/322

(57) ABSTRACT

A method for removing benzene from water, by mixing aluminum oxide nanoparticle-impregnated multi-walled carbon nanotubes with a solution containing water and benzene to obtain a suspension containing the aluminum oxide nanoparticle-impregnated multi-walled carbon nanotubes, the water and the benzene, and then applying ultraviolet light to the suspension and stirring the suspension to remove at least a portion of the benzene from water.

### BACKGROUND OF THE INVENTION

Field of the Disclosure

The present invention relates to a method for removing benzene from water by mixing multi-walled carbon nanotubes (MWCNTs) that are impregnated with aluminum oxide nanoparticles with a solution comprising water and benzene. LED-UV is applied additionally to achieve fast removal.

Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

Benzene is one of the widely used aromatic hydrocarbons in many industries. It is among twenty most used chemicals in the United States. Benzene is a natural part of petroleum fractions and is also generated by different processes in refineries. Different uses of benzene include use as a raw material for producing various polymers and plastics and also as a solvent in paint and other industries (John J. McKetta Jr, Encyclopedia of Chemical Processing and Design: Volume 67—Water and Wastewater Treatment: Protective Coating Systems to Zeolite. CRC Press, 1999, p. 289; J. A. Kent, Kent and Riegel's Handbook of Industrial Chemistry and Biotechnology: Vol. 1. Springer Science & Business Media, 2010, p. 391; C. Kent, Basics of Toxicology, vol. 13. John Wiley & Sons, 1998, p. 194—each incorporated by reference in their entirety). However, benzene causes different diseases in human beings which range from skin diseases to cancer. The allowable limit of benzene in drinking water is 5 ppb as advised by EPA (O. US EPA, “Drinking Water Contaminants”—incorporated by reference in its entirety).

Thus, benzene is a toxic and carcinogenic chemical used in different industries at a wide scale. Consequently, it is necessary to get rid of benzene from water before discharging it to the environment. The removal of benzene from water has been carried out by researchers using different methods. These methods include photo-catalytic degradation, advanced oxidation processes, wet air oxidation and adsorption (M. Bahmani, V. Bitarafhaghighi, K. Badr, P. Keshavarz, and D. Mowla, “The photocatalytic degradation and kinetic analysis of BTEX components in polluted wastewater by UV/H 2 0 2-based advanced oxidation,” Desalin. Water Treat., vol. 52, no. 16-18, pp. 3054-3062, May 2013; B. A. Abussaud, N. Ulkem, D. Berk, and G. J. Kubes, “Wet Air Oxidation of Benzene,” Ind. Eng. Chem. Res., vol. 47, no. 514, pp. 4325-4331,2008; F. Su, C. Lu, and S. Hu, “Adsorption of benzene, toluene, ethylbenzene and p-xylene by NaOCl-oxidized carbon nanotubes,” Colloids Surfaces A Physicochem. Eng. Asp., vol. 353, no. 1, pp. 83-91, January 2010; N. Wibowo, L. Setyadhi, D. Wibowo, J. Setiawan, and S. Ismadji, “Adsorption of benzene and toluene from aqueous solutions onto activated carbon and its acid and heat treated forms: influence of surface chemistry on adsorption.,” J. Hazard. Mater., vol. 146, no. 1-2, pp. 237-242, July 2007—each incorporated by reference in their entirety).

Adsorption has been the most promising technique and widely used for industrial applications (I. Ali and V. K. Gupta, “Advances in water treatment by adsorption technology.,” Nat. Protoc., vol. 1, no. 6, pp. 2661-7, January 2006—incorporated by reference in its entirety). Carbon based nanomaterials, such as carbon nanotubes, have been found suitable for this application due to their unique properties (S. Iijima, “Helical microtubules of graphitic carbon,” Nature, vol. 354, no. 6348, pp. 56-58, 1991—incorporated by reference in its entirety). These materials have high aspect ratio, ability for functionalization, and unique electrical, mechanical and physical properties. Modified carbon nanotubes have been used for removal of benzene and other materials, providing more promising results (F. Su, C. Lu, and S. Hu, “Adsorption of benzene, toluene, ethylbenzene and p-xylene by NaOCl-oxidized carbon nanotubes,” Colloids Surfaces A Physicochem. Eng. Asp., vol. 353, no. 1, pp. 83-91, January 2010; V. K. Gupta, S. Agarwal, and T. a Saleh, “Chromium removal by combining the magnetic properties of iron oxide with adsorption properties of carbon nanotubes.,” Water Res., vol. 45, no. 6, pp. 2207-12, March. 2011—each incorporated by reference in their entirety).

In order to enhance the removal efficiency and to obtain more promising results, the present study has combined the adsorption effect of aluminum oxide impregnated carbon nanotubes with degradation effect of LED-UV, for the first time, for removal of benzene from water. Aluminum oxide impregnated CNTs have been found to have better adsorption capacity as compared to raw CNTs.

### BRIEF SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

One embodiment of the disclosure relates to a method for removing benzene from water, comprising: mixing aluminum oxide nanoparticles impregnated-multi-walled carbon nanotubes with a solution comprising water and benzene to obtain a suspension comprising the aluminum oxide nanoparticle-impregnated multi-walled carbon nanotubes, the water, and the benzene; and then applying ultraviolet light to the suspension and stirring the suspension to remove at least a portion of the benzene from water.

In another embodiment, the method further comprises impregnating the multi-walled carbon nanotubes with aluminum oxide nanoparticles.

In one embodiment of the invention, the impregnating comprises dissolving the multi-walled carbon nanotubes in ethanol to obtain a sample, dissolving aluminum nitrate in ethanol to obtain a solution, mixing the sample comprising the multi-walled carbon nanotubes with the solution comprising aluminum nitrate to obtain a mixture, sonicating the mixture, drying the mixture, and then performing calcination.

In one embodiment, the multi-walled nanotube can adopt the Russian Doll model.

In another embodiment, the multi-walled nanotube can adopt the parchment model.

In an embodiment the ultraviolet light has a wavelength of about 365 nm and a power of about 20 W.

In another embodiment the benzene is not converted to other organic compounds.

In another embodiment the treatment time of the applying of the ultraviolet light to the suspension is from 1 to 3 hours.

In another embodiment, the method comprises removing benzene in a batch process.

In another embodiment, the aluminum oxide nanoparticles have a particle size ranging from 1 to 15 nm.

In one embodiment, an amount of the aluminum oxide nanoparticles-impregnated multi-walled carbon nanotubes to the water solution comprising benzene ranges from 0.2 to 1 g/L.

In one aspect of the invention, the percentage of benzene removed after ultraviolet light treatment time of 1 hour is greater than 45%.

In one embodiment, the percentage of benzene removed after ultraviolet light treatment time of 2 hours is greater than 85%.

In another embodiment, the percentage of benzene removed after ultraviolet light treatment time of 3 hours is greater than 95%.

### BRIEF DESCRIPTION OF THE DRAWINGS

FIG. 1 is a SEM image of aluminum oxide nanoparticles impregnated carbon nanotubes.

FIG. 2 is graph showing EDX spectrum of aluminum oxide nanoparticles impregnated carbon nanotubes.

FIG. 3 is a graph showing thermogravimetric analysis curves for raw and modified carbon nanotubes.

FIG. 4 is a graph showing removal of benzene from water over time using LED-UV without carbon nanotubes and LED-UV with carbon nanotubes.

### DETAILED DESCRIPTION

The present disclosure relates to a method for removing benzene from water, comprising:

(i) mixing aluminum oxide nanoparticles impregnated-multi-walled carbon nanotubes with a solution comprising water and benzene to obtain a suspension comprising the aluminum oxide nanoparticle-impregnated multi-walled carbon nanotubes, the water, and the benzene; and then

(ii) applying ultraviolet light to the suspension and stirring the suspension to remove at least a portion of the benzene from water.

Carbon nanotubes as used herein are allotropes of carbon with a cylindrical nanostructure and are members of the fullerene structural family. Carbon nanotubes have a long, hollow structure with the walls formed by one-atom-thick sheets of carbon, called graphene. Graphene is a 2-dimensional crystalline allotrope of carbon, where the carbon atoms are densely packed in a regular sp²-bonded hexagonal pattern. Graphene as used herein are in the form of platelets of graphene layers having a thickness of from 200 to 700 angstroms, preferably from 400 to 600 angstroms. These sheets are rolled at specific and discrete (“chiral”) angles, and the combination of the rolling angle and radius decides the nanotube properties.

Nanotubes are categorized as single-walled nanotubes and multi-walled nanotubes. Most single-walled nanotubes have a diameter of close to 1 nanometer, but may be larger, and have a tube length that can be many millions of times longer. The structure of a single-walled nanotube can be conceptualized by wrapping a one-atom-thick layer of graphite called graphene into a seamless cylinder. Alternatively, multi-walled nanotubes consist of multiple rolled layers (concentric tubes) of graphene. There are two models that can be used to describe the structures of multi-walled nanotubes. In the Russian Doll model, sheets of graphite are arranged in concentric cylinders, for example, a single-walled nanotube within a larger single-walled nanotube. In the Parchment model, a single sheet of graphite is rolled in around itself, resembling a scroll of parchment or a rolled newspaper. The carbon nanotubes of the present disclosure are multi-walled carbon nanotubes, which can adopt the Russian Doll model or the Parchment model.

In certain embodiments, the carbon nanotubes used in the process for making a carbon nanotube membrane have an outer diameter of 5 to 50 nm, preferably 7.5 to 25 nm, more preferably 10 to 20 nm, and a length of 0.1 to 100 μm, preferably 0.5 to 50 μm, more preferably 1 to 20 μm. In one embodiment, the carbon nanotubes have an outer diameter of 10 to 20 nm and a length of 1 to 10 μm, thereby resulting in a length-to-diameter ratio of 50 to 1000, preferably 100 to 750, more preferably 250 to 500. The carbon nanotubes used for the making of the carbon nanotube membrane may be synthesized using any conventional technique including but not limited to arc discharge, laser ablation, high-pressure carbon monoxide disproportionation and chemical vapor deposition (CVD), and are not so limited. The carbon nanotubes used have a purity of 95% or higher, preferably ≧98%, more preferably ≧99%, with an ash content of less than 1.5 wt. %, preferably less than 1.0%, more preferably less than 0.75 wt. %. The specific surface area of the carbon nanotubes is at least 100 m²/g, preferably 200 to 750 m²/g, more preferably 250 to 500 m²/g. The electrical conductivity of the carbon nanotubes is at least 10² s/cm, preferably 10² to 10⁵ s/cm, more preferably 10³ to 10⁴ s/cm.

The multi-walled carbon nanotube membrane has a porous morphology and the porosity can be measured by a variety of known techniques such as but not limited to dry-wet weight measurements, destructive methods that require a sample to be crushed (e.g. Melcher-Nutting, Russell), and gas expansion methods (e.g. with Boyle's law porosimeter). The porosity of the membrane ranges from 50 to 80%, preferably 55 to 75%, more preferably 60 to 70%. The membrane has a total pore volume, as determined by a porosimeter by a mercury injection method or a fluid saturation method, of 0.05 to 0.5 cm³/g, preferably 0.1 to 0.5 cm³/g, more preferably 0.2 to 0.5 cm³/g. In one or more embodiments, the carbon nanotube membrane is a mesoporous material having an average pore diameter of from 0.05 to 20 nm, preferably 0.1 to 15 nm, more preferably 5 to 10 nm.

In the present disclosure the aluminum oxide nanoparticles may be affixed to the MWCNTs in any reasonable manner, such as affixed to the surface of the nanotubes through a covalent bond, or alternately, affixed to the multi-walled carbon nanotubes through a non-bonded interaction such as a Van der Waals force. The aluminum oxide nanoparticles may interact with the surface of the multi-walled carbon nanotube, or it may be at least partially embedded within the multi-walled carbon nanotube mesoporous structure, or a mixture thereof. When used herein, the term “embedded” or “encapsulated” refers to elements which are integral to, or highly connected and incorporated with, the MWCNTs structure, as opposed to being present only on the surface of the MWCNTs structure. There may also be varying degrees of encapsulation, for instance the aluminum oxide nanoparticles may be fully encapsulated within a pore such that no part of the particle protrudes from the pore cavity. Alternatively, the aluminum oxide nanoparticles may be partially encapsulated such that a portion of the nanoparticles is inside the cavity and a portion of the nanoparticles protrudes from the pore cavity.

The method may optionally comprise a step of impregnating the multi-walled carbon nanotubes with aluminum oxide nanoparticles, which comprises:

(a) dissolving multi-walled carbon nanotubes in an organic solvent, followed by sonication;

(b) dissolving aluminum nitrate salt in an organic solvent;

(c) mixing the products of (a) and (b) to obtain a mixture;

(d) sonicating the mixture;

(e) drying the sonicated mixture; and

(f) calcinating the dried mixture.

In one embodiment, the multi-walled carbon nanotubes in the dissolving (a) are dissolved in at least one organic solvent selected from the group consisting of ethanol, methanol, ethylene glycol, 1,2-dichlorobenzene, chloroform, 1-methylnaphthalene, 1-bromo-2-methylnaphthalene, N-Methylpyrrolidinone, dimethylformamide, tetrahydrofuran, 1,2-dimethylbenzene, pyridine, carbon disulfide, 1,3,5-trimethylbenzene, acetone, 1,3-dimethylbenzene, 1,4-dimethylbenzene, and toluene. Preferably, the organic solvent is ethanol.

An amount of the multi-walled carbon nanotubes added to the organic solvent ranges from 10 to 50 g per 1 L of organic solvent, preferably from 20 to 30 g per 1 L of organic solvent, or preferably from 10 to 20 g per 1 L of organic solvent.

After dissolving the multi-walled carbon nanotubes in the organic solvent, the dissolved sample is sonicated for a time period ranging from 15 minutes to 1 hour, preferably from 20 minutes to 50 minutes, especially preferably from 30 minutes to 45 minutes.

The organic solvent in the dissolving (b) is at least one selected from the group consisting of ethanol, methanol, ethylene glycol, 1,2-dichlorobenzene, chloroform, 1-methylnaphthalene, 1-bromo-2-methylnaphthalene, N-Methylpyrrolidinone, dimethylformamide, tetrahydrofuran, 1,2-dimethylbenzene, pyridine, carbon disulfide, 1,3,5-trimethylbenzene, acetone, 1,3-dimethylbenzene, 1,4-dimethylbenzene, and toluene. Preferably, the organic solvent is ethanol. It is preferred that the organic solvent in the dissolving (a) and the dissolving (b) are the same, in order to promote proper distribution in the mixing (c).

An amount of the aluminum nitrate salt added to the organic solvent ranges from 1 to 10 g per 1 L of organic solvent, preferably from 1 to 5 g per 1 L of organic solvent, or preferably from 5 to 10 g per 1 L of organic solvent.

The aluminum oxide nanoparticles obtained from the dissolving (b) have a particle size ranging from 1 to 90 nm, preferably from 1 to 80 nm, particularly preferably from 1 to 30 nm, preferably from 1 to 20 nm, especially preferably from 1 to 15 nm.

After mixing the sample obtained from (a) comprising the multi-walled carbon nanotubes in the organic solvent and the solution obtained from (b) comprising the aluminum nitrate dissolved in the organic solvent, the mixture is sonicated (d) to obtain proper distribution, for a time period ranging from 15 minutes to 1 hour, preferably from 20 minutes to 50 minutes, especially preferably from 30 minutes to 45 minutes.

After the (d) sonication of the mixture, the mixture is completely dried (e), at a temperature ranging from 80 to 120° C., preferably from 85 to 110° C., especially preferably from 80 to 100° C.

After the (e) drying, the dried sample is placed in a furnace for calcination (f). The calcination is performed at a temperature ranging from 300 to 400° C., preferably from 315 to 385° C., especially preferably from 325 to 375° C., particularly preferably about 350° C. The calcination is performed for a time period ranging from 2 to 8 hours, preferably from 3 to 7 hours, especially preferably from 4 to 5 hours.

The aluminum oxide nanoparticles impregnated multi-walled carbon nanotubes lose 50% of their weight at a temperature ranging from 550 to 650° C., preferably from 575 to 625° C., especially preferably from 590 to 610° C., particularly preferably about 600° C.

In step (ii) of mixing the aluminum oxide nanoparticles-impregnated multi-walled carbon nanotubes with a solution comprising water and benzene, a content of the benzene in the water solution may be concentrated, ranging from 750 to 1500 ppm, preferably from 800 to 1200 ppm, especially preferably from 900 to 1100 ppm, particularly preferably about 1000 ppm. In another embodiment, a content of the benzene in the benzene solution may be diluted, ranging from 1 to 50 ppm, preferably from 2 to 40 ppm, more preferably from 3 to 30 ppm, even more preferably from 5 to 20 ppm, especially preferably from 8 to 15 ppm and particularly preferably from 9 to 12 ppm.

An amount of the aluminum oxide nanoparticles-impregnated multi-walled carbon nanotubes to the water solution comprising benzene ranges from 0.2 to 1 g/L, preferably from 0.3 to 0.8, particularly preferably from 0.4 to 0.7, especially preferably from 0.5 to 0.6 g/L.

A weight percent of the aluminum oxide nanoparticles relative to the total weight of the aluminum oxide nanoparticles-impregnated multi-walled carbon nanotubes ranges from 1 to 20 weight %, preferably from 3 to 17 weight %, especially preferably from 5 to 15 weight %, particularly preferably from 7 to 12 weight %.

The step (ii) of applying ultraviolet light to the solution with stirring to remove at least a portion of the benzene from water, comprises applying ultraviolet light having a wavelength ranging from 350 to 400 nm, preferably from 355 to 385 nm, especially preferably from 360 to 380 nm, particularly preferably about 365 nm, and a power ranging from 15 to 35 W, preferably from 17 to 30 W, particularly preferably from 18 to 25 W, especially preferably about 20 W. In terms of the present disclosure, the UV light source may include a black light (e.g. phosphor-based, mercury-vapor, etc.), a gas-discharge lamp (magnesium fluoride, argon and deuterium arc lamps, an excimer lamp, etc.), a UV LED (diamond, boron nitride, aluminum nitride, aluminum gallium nitride, aluminum gallium indium nitride, etc.), and a UV laser (e.g. nitrogen gas, argon-fluoride, cerium doped lithium strontium aluminum fluoride, diode-pumped solid-state laser, etc.).

In one embodiment, the UV light source has an intensity of 90-120, preferably 95-115, more preferably 100-110 μW/cm².

The UV light of the present disclosure may be emitted from a UV lamp having several forms. In one embodiment, the UV lamp is located above the suspension. In one embodiment, the UV light source and/or UV lamp is located 1-20 cm, preferably 1-15 cm, more preferably 1-10 cm above the suspension. Alternatively, the UV light source may be water proof, or water resistant, and the UV lamp is submerged in the suspension. In the case where the UV light source is submerged, the UV light source may be encased in a barrier, such as for example a water proof casing, housing, or membrane, so long as the barrier permits UV light to pass through while preventing water egress into the encased UV lamp. In one embodiment, the water proof casing is a transparent water proof barrier. In an alternative embodiment, the UV light source may comprise a plurality of UV lights (i.e. LEDs, individual light bulbs, etc.), and the UV lights may be spaced apart in a variety of vertically and horizontally separated levels. In this scenario, the spaced UV light sources may either be located above the suspension, or alternatively submerged under the suspension. Further, the UV light sources may be located both above the suspension and submerged in the suspension. As an example, the suspension may be irradiated with a plurality of UV light sources where the UV sources are spaced apart around the suspension circumferentially.

The aluminum oxide nanoparticles impregnated multi-walled carbon nanotubes are treated with ultraviolet light for a treatment period ranging from 1 to 5 hours, preferably from 1.5 to 4 hours, particularly preferably from 2 to 3.5 hours, especially preferably about 3 hours.

The percentage of benzene removed after a treatment time of 1 hour is greater than 30%, preferably greater than 40%, particularly preferably greater than 45%. The percentage of benzene removed after a treatment time of greater than 1 hour is greater than 45%, preferably greater than 50%, particularly preferably greater than 60%, and especially preferably greater than 70%. The percentage of benzene removed after a treatment time of 2 hours is greater than 70%, preferably greater than 75%, particularly preferably greater than 80%, especially preferably greater than 85%. The percentage of benzene removed after a treatment time of 3 hours is greater than 85%, preferably greater than 90%, especially preferably greater than 95%, particularly preferably greater than 97%.

Preferably, after treatment with ultraviolet light, a total content of the benzene left in the suspension is less than 5 ppm, preferably less than 4 ppm, more preferably less than 3 ppm, especially preferably less than 2 ppm, and particularly preferably less than 1 ppm.

In another embodiment, the aluminum oxide nanoparticles impregnated multi-walled carbon nanotubes are treated with ultraviolet light in cycles. The cycles range from 15 to 90 minutes, preferably from 20 to 75 minutes, especially preferably about 30 minutes. After each cycle of irradiation, the nanocomposites are cooled to room temperature for a time period ranging from 1 to 10 minutes, preferably from 2 to 8 minutes, especially preferably about 5 minutes. The cooling time avoids the effect of heat on the aluminum oxide nanoparticles impregnated multi-walled carbon nanotubes. Room temperature as used herein ranges from 20 to 26° C., preferably from 22 to 25° C.

### EXAMPLE

Commercial multiwall carbon nanotubes were purchased from “Timesnano” with purity of greater than 95% (weight). Other chemicals; aluminum nitrate, ethanol, benzene (99.7% purity), nitric acid (>69% purity) and sodium hydroxide of analytical grade, were purchased from Sigma Aldrich and used without any treatment.

In order to prepare aluminum oxide nanoparticles impregnated MWCNTs, required amount of MWCNTs was weighed and dissolved in sufficient amount of ethanol. 18 g of MWCNTs was dissolved in a 1 L ethanol solution. The sample was ultra-sonicated for half an hour. Aluminum nitrate salt (weight 2 g) was also dissolved in ethanol and was transferred to MWCNTs sample and sonicated for further half an hour for proper distribution. Then the sample was dried at 90° C. and on complete drying, the sample was shifted to furnace for calcination at 350° C. for a 4 hour period.

The light source used for this experimentation was LED-UV having wavelength of 365 nm and power of 20 W.

Benzene removal experiments were carried out in batch process. 1000 ppm benzene stock solution was prepared in deionized distilled water. Stock solution was diluted to achieve required concentration. 1000 ml sample was taken in a beaker and placed on magnetic stirrer and LED-UV light source was applied. The samples were collected at different timings and after filtration concentration was analyzed using GCMS. In another batch, aluminum oxide nanoparticles impregnated CNTs were added in a beaker containing benzene solution and placed on magnetic stirrer while LED-UV light source was also applied. The amount of aluminum oxide nanoparticles impregnated CNTs added was 0.5 g/L.

Percentage removal was found using equation (1).

$$Removal ( \% ) = \frac{{C}_{0} - C}{{C}_{0}} * 100 \qquad ( 1 )$$

where

C₀=Initial concentration of benzene in sample (mg/l)

C=Concentration at any time (mg/l).

Aluminum oxide nanoparticles impregnated carbon nanotubes were analyzed using different techniques including thermogravimetric analysis (TGA) and scanning electron microscopy (SEM). Benzene concentration was analyzed using GCMS (Gas chromatography-mass spectrometry) and TOC (total organic carbon) analysis was performed in order to measure total organic carbon in the samples.

### Results and Discussion

### Characterization of Adsorbents

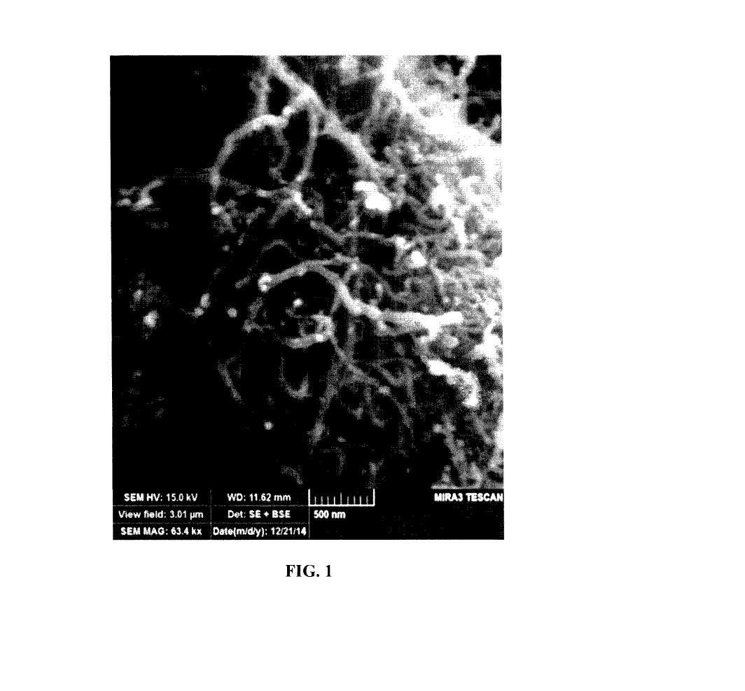

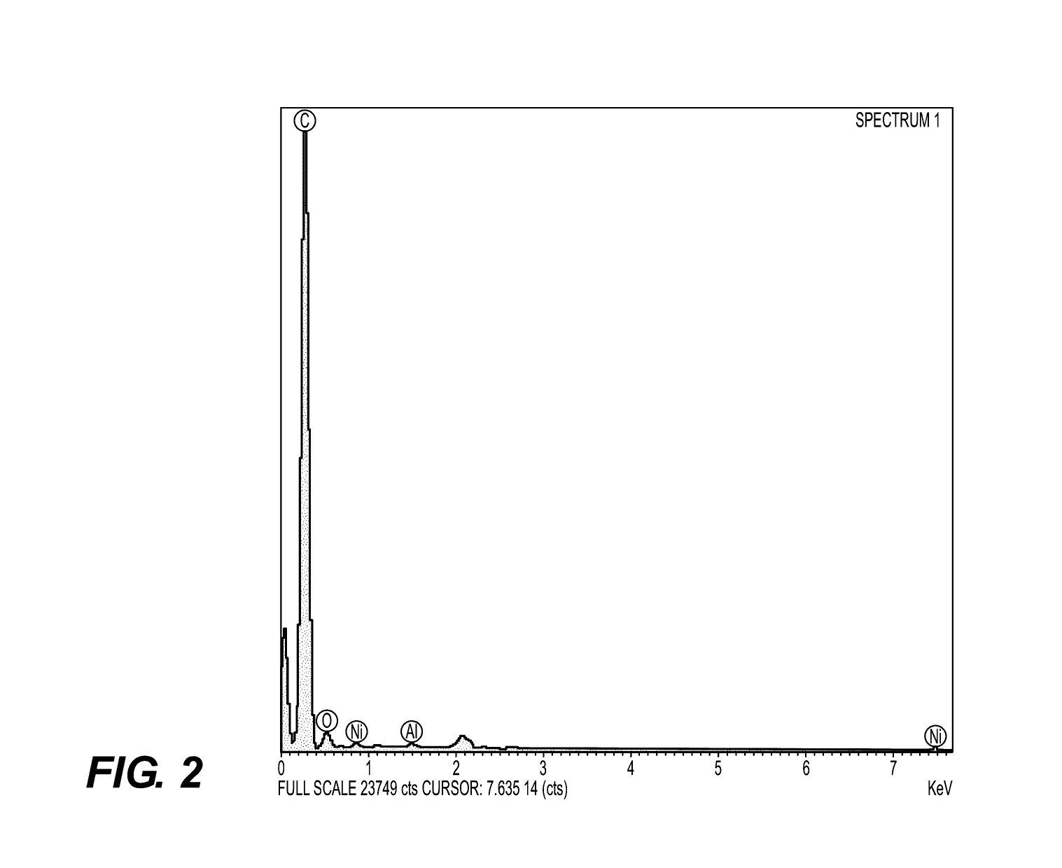

Raw MWCNTs and aluminum oxide nanoparticles impregnated MWCNTs were analyzed using SEM as shown in FIG. 1. It is evident from FIG. 1 that metal oxide clusters are present and the CNTs seem more distributed. EDX (energy dispersive X-ray) analysis was also performed to confirm the impregnation of CNTs with aluminum oxide nanoparticles and spectrum, as shown in FIG. 2.

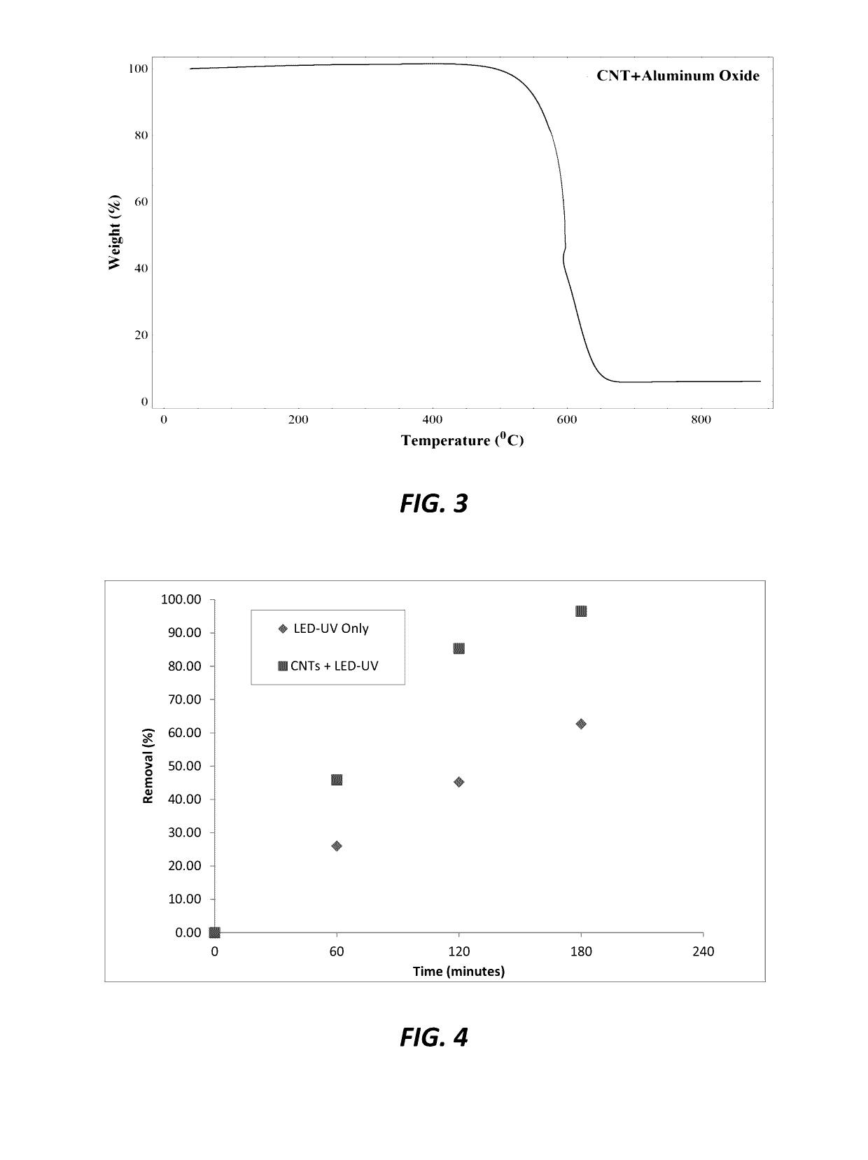

FIG. 3 represents the thermogravimetric analysis of aluminum oxide nanoparticles MWCNTs.

### TOC Analysis

In order to investigate the phenomena of removal of benzene from water, using modified CNTs and light source together, TOC analysis was carried out. Table 1 below demonstrates that TOC decreased with time, which indicates that benzene was converted to such components that were adsorbed on the surface of CNTs. The value of TOC reduced with time, which indicates that in the presence of LED-UV, benzene was not converted to other organic compounds which stay present in the water, and hence, no further treatment is required.

TABLE 1
TOC analysis

| Source of treatment | Initial TOC | Final TOC |
|---|---|---|
| CNTs + LED UV-light | 11.92 | 2.88 |

### Degradation and Adsorption Analysis

The results for degradation and adsorption of benzene from water, using aluminum oxide nanoparticles impregnated CNTs together with LED-UV are presented in FIG. 4. It can be observed from FIG. 4 that by using LED-UV alone, the removal of benzene increased with passing time and hence after three hours of treatment maximum removal achieved was 63%. In another batch, aluminum oxide nanoparticles impregnated CNTs were used together with LED-UV. It was found again that removal efficiency enhanced with time and it was higher than LED-UV alone. Maximum removal achieved in this case after three hours was 97%. Total organic carbon (TOC) analysis indicates the removal of benzene from solution instead of conversion to other compounds. It supports that removal efficiency was enhanced by using light source along with adsorbents.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, define, in part, the scope of the foregoing claim terminology such that no inventive subject matter is dedicated to the public.

1: A method for removing benzene from water, comprising:
(i) mixing aluminum oxide nanoparticle-impregnated multi-walled carbon nanotubes with a solution comprising water and benzene to obtain a suspension comprising the aluminum oxide nanoparticle-impregnated multi-walled carbon nanotubes, the water and the benzene; and then
(iii) applying ultraviolet light to the suspension and stirring the suspension to remove at least a portion of the benzene from water.

2: The method of claim 1, further comprising impregnating the multi-walled carbon nanotubes with aluminum oxide nanoparticles, which comprises:
(a) dissolving multi-walled carbon nanotubes in an organic solvent, followed by sonication;
(b) dissolving aluminum nitrate salt in an organic solvent;
(c) mixing the products of (a) and (b) to obtain a mixture;
(d) sonicating the mixture;
(e) drying the sonicated mixture; and
(f) calcinating the dried mixture.

3: The method of claim 2, wherein the organic solvent in (a) and (b) are each ethanol.

4: The method of claim 1, wherein the aluminum oxide nanoparticles have a particle size ranging from 1 to 15 nm.

5: The method of claim 1, wherein an amount of the aluminum oxide nanopailicles-impregnated multi-walled carbon nanotubes to the water solution comprising benzene ranges from 0.2 to 1 g/L.

6: The method of claim 1, wherein the ultraviolet light has a wavelength ranging from 350 to 400 nm and a power ranging from 15 to 35 W.

7: The method of claim 1, wherein the ultraviolet light has a wavelength of about 365 nm and a power of about 20 W.

8: The method of claim 1, wherein the benzene is not converted to other organic compounds.

9: The method of claim 1, wherein a treatment time of the applying of the ultraviolet light to the suspension is from 1 to 3 hours.

10: The method of claim 9, wherein the treatment time is about 3 hours.

11: The method of claim 9, wherein a percentage of benzene removed after a treatment time of 1 hour is greater than 45%.

12: The method of claim 9, wherein a percentage of benzene removed after a treatment time of 2 hours is greater than 85%.

13: The method of claim 9, wherein a percentage of benzene removed after a treatment time of 3 hours is greater than 95%.

14: The method of claim 1, wherein a weight percent of the aluminum oxide nanoparticles relative to the total weight of the aluminum oxide nanoparticles-impregnated multi-walled carbon nanotubes ranges from 1 to 20 weight %.

15: The method of claim 1, wherein a total content of the benzene left in the suspension after treatment with ultraviolet light is less than 5 ppm.
